(19) United States
(12) Patent Application Publication
(10) Pub. No.: US 2026/0348532 A1
(43) Pub. Date: Nov. 5, 2026

(54) DISCHARGE VALVE WITH IMPROVED DISCHARGE CONTROL

(71) Applicant: ROTAREX S.A., Roost (Bissen) (LU)

(72) Inventors: Thomas ANDREAS, Temmels (DE); Fabien DESNOES, Montigny-Lès-Metz (FR); Philippe SCHMITZ, Steinsel (LU)

(21) Appl. No.: 19/139,596

(22) PCT Filed: Dec. 18, 2023
(86) PCT No.: PCT/EP2023/086248

§ 371 Date: Jun. 16, 2025

(30) Foreign Application Priority Data
Dec. 16, 2022 (LU) LU503202

(51) Int. Cl. F17C 13/04; F16K 5/06; F16K 31/122

(52) U.S. Cl. CPC F17C 13/04; F16K 5/0647; F16K 31/1221; F16K 31/1223; F17C 2205/0382; F17C 2250/0478; F17C 2270/0754

(57) ABSTRACT

A discharge valve for a tank containing a compressed medium, comprising a body, and a passage; a shut-off device in the passage, comprising a seat in the passage; a movable assembly comprising an obturator; a piston delimiting in the body a control chamber; and a controlled gas passage fluidly interconnecting the control chamber with an inlet; a control port located on a top body part and fluidly connected to the control chamber; and a shut-off valve fluidly between the control chamber and the control port; wherein the shut-off valve comprises a perforated ball and ball seats housed in a bore formed in the top body part; and a spindle extending transversally through the top body part and with a proximal end engaging with the perforated ball.

### CROSS-REFERENCE TO RELATED APPLICATIONS

The present invention is the US national stage under 35 U.S.C. § 371 of International Application No. PCT/EP2023/086248 which was filed on Dec. 18, 2023, and which claims the priority of application LU503202 filed on Dec. 16, 2022, the contents of which (text, drawings and claims) are incorporated here by reference in their entirety.

### FIELD

The invention is directed to the field of discharge valves for tanks, in particular cylinders, containing a compressed medium e.g., compressed gas like CO2, with a capacity of being opened in large e.g., for extinguishing a fire.

### BACKGROUND

The patent document published WO 2010/149639 A1 discloses a high-pressure gas discharge valve for a fire-extinguishing or explosion-preventing system, comprising a body comprising an engaging portion for sealingly engaging with a tank, an inlet, an outlet, and a passage fluidly connecting the inlet and the outlet; a shut-off device in the gas passage, comprising a seat in the passage; a movable element comprising an obturator for cooperating with the seat; a piston delimiting in the body a control chamber; and a controlled passage fluidly interconnecting the control chamber with the inlet; a control port located on a top body part closing the control chamber, and fluidly connected to the control chamber; and a shut-off valve fluidly between the control chamber and the control port. The controlled passage fluidly interconnecting the control chamber with the inlet is formed by a bore through the movable element and a pressure regulator slidably received in the piston and the obturator. The control chamber is intended to be fluidly connected, via the control port and the shut-off valve, to a security conduit that extends through the room(s) to be fire-protected with the discharge valve. The pressure in that security conduit is substantially lower than the pressure in the tank containing the pressurized fire-extinguishing gas.

In normal operating conditions, the discharge valve is closed by filling the security conduit with gas at a minimum pressure which acts on the piston and the obturator so as to close the passage from the inlet to the outlet. In case of fire, the security conduit gets damaged resulting in leaking and releasing the control pressure in the control chamber. The resulting force exerted on the piston drops down to a value lower than the resulting opposed force exerted by the gas pressure at the inlet on the obturator, leading to a movement thereof that opens the passage to the outlet.

The pressure regulator integrated in the piston and obturator provides a pressure reduction between the nominal inlet pressure and the pressure in the control chamber that is required for holding the obturator in the closed position.

A shut-off valve is provided between the control chamber and the control port to the security conduit. This shut-off valve is useful for connecting the security conduit. That shut-off valve must however remain opened after installation, during normal operation. By being external to the body of the discharge valve, that shut-off valve is therefore bulky and accessible to any person. It can therefore be manually operated by any person having access to the discharge valve.

### SUMMARY OF INVENTION

The invention has for objective to overcome at least one drawback of the prior art, more particularly to provide a discharge valve for a medium of a fire-extinguishing or explosion-preventing system that is more compact and more secure with regard to the position of the shut-off valve interconnecting the control chamber with the control port to the security conduit.

The invention is directed to a discharge valve for a tank containing a compressed medium, comprising a body comprising an engaging portion for sealingly engaging with the tank, an inlet, an outlet, and a passage fluidly connecting the inlet and the outlet; a shut-off device in the passage, comprising a seat in the passage; a movable assembly comprising an obturator for cooperating with the seat; a piston delimiting in the body a control chamber; and a controlled gas passage fluidly interconnecting the control chamber with the inlet; a control port located on a top body part closing the control chamber, and fluidly connected to the control chamber; and a shut-off valve fluidly between the control chamber and the control port; wherein the shut-off valve comprises a perforated ball and ball seats housed in a bore formed in the top body part and opening out in the control chamber; and a spindle extending transversally through the top body part and with a proximal end engaging with the perforated ball.

According to a preferred embodiment, the spindle comprises a distal end shaped for being engaged by a tool or an operator's hand.

According to a preferred embodiment, the distal end of the spindle is housed in a cavity formed in a lateral outer surface of the top body part.

According to a preferred embodiment, the cavity comprises a hole, preferably a blind hole, housing a spring plunger configured for selectively resiliently engaging with one or more recesses formed on the distal end of the spindle, corresponding to predetermined position(s) of the shut-off valve.

According to a preferred embodiment, the discharge valve further comprises a ring engaging with the cavity and the distal end of the spindle so as to retain said distal end in said cavity. Advantageously, the distal end of the spindle and the ring comprise each, on front faces thereof, markings which are arranged for matching with each other depending on angular positions of the spindle, thereby providing a visual indication of said angular position and state of the shut-off valve.

According to a preferred embodiment, the discharge valve further comprises a lid hinged on the body, preferably on the top body part, and configured for covering the distal end of the spindle.

According to a preferred embodiment, the lid and the body comprises holes through which a tampering wire can be inserted when said lid is in a closed position preventing access to the distal end of the spindle.

According to a preferred embodiment, the discharge valve further comprises an electric detector of position of the shut-off valve.

According to a preferred embodiment, the electric detector of position of the shut-off valve comprises a permanent magnet attached to the spindle; and a reed contact housed in a hole of the top body part at proximity to the permanent magnet of the spindle so as to be able to be activated by said permanent magnet when the spindle is rotated in a predetermined position.

According to a preferred embodiment, the discharge valve further comprises an electric detector of position of the piston.

According to a preferred embodiment, the electric detector of position of the shut-off valve comprises a permanent magnet attached to the piston; and a reed contact housed in a hole of the top body part at proximity to the permanent magnet of the piston so as to be able to be activated by said permanent magnet when the piston is in an upper position in contact with, or at least adjacent to the top body part.

According to a preferred embodiment, the discharge valve further comprises a rod engaging longitudinally with the body and with the piston as to prevent rotation of the piston relative to the body.

According to a preferred embodiment, the discharge valve further comprises a spigot engaging the bore formed in the top body part and retaining the perforated ball and the ball seats in said bore, said spigot extending longitudinally into the control chamber with radial passages for the medium and with a front sealing surface configured to be engaged in a medium tight fashion by the controlled passage when the piston is in a raised position adjacent the top body part.

According to a preferred embodiment, the obturator and the piston are rigidly fixed to each other, preferably unitary, and comprise a pressure regulator slidably received in said piston and obturator, and forming the controlled passage between the inlet and the control chamber, said pressure regulator comprising a seat around the controlled passage, configured for engaging with the sealing surface of the spigot.

According to a preferred embodiment, the control port is orientated transversally, opposed to the spindle relative to the shut-off valve.

The above features are advantageous in that they provide a discharge valve with improved integration and resulting security. The integration the shut-off valve in the body, for instance in the top body part, not only protects the shut-off valve from external aggressions but also renders the discharge valve more compact. The integration of the shut-off valve in the body provides also a better control of access to the shut-off valve e.g., by means of the lid preventing access to the spindle of the shut-off valve and the tool necessary for engaging in rotation with the distal end of said spindle. The integration of the shut-off valve in the body allows also the integration of an electric detector of one or more operating positions of said valve. The integration the shut-off valve in the body is advantageously in the top body part which is machined along the longitudinal axis of the discharge valve only on the side delimiting the control chamber, and transversally to said longitudinal axis, thereby optimizing the machining operations. The electric detector of position of the piston further increases the security of the discharge valve in that it detects when the discharge valve is totally opened, provides a manufacturing cost reduction in replacement of a pressure switch and provides more robust and compact construction. The reed contact of that electric detector can be also housed in the top body part, thereby concentrating similar machine operations in the top body part.

### BRIEF DESCRIPTION OF THE DRAWINGS

FIG. 1 is a perspective view of a discharge valve for a tank containing a compressed medium, according to various embodiments of the invention.

FIG. 2 is a longitudinal sectional view of the discharge valve of FIG. 1, according to various embodiments of the invention.

FIG. 3 is another longitudinal sectional view of the discharge valve of FIG. 1, according to various embodiments of the invention.

FIG. 4 is a perspective view of the spindle of the shut-off valve of the discharge valve of FIGS. 1 to 3, according to various embodiments of the invention.

### DETAILED DESCRIPTION

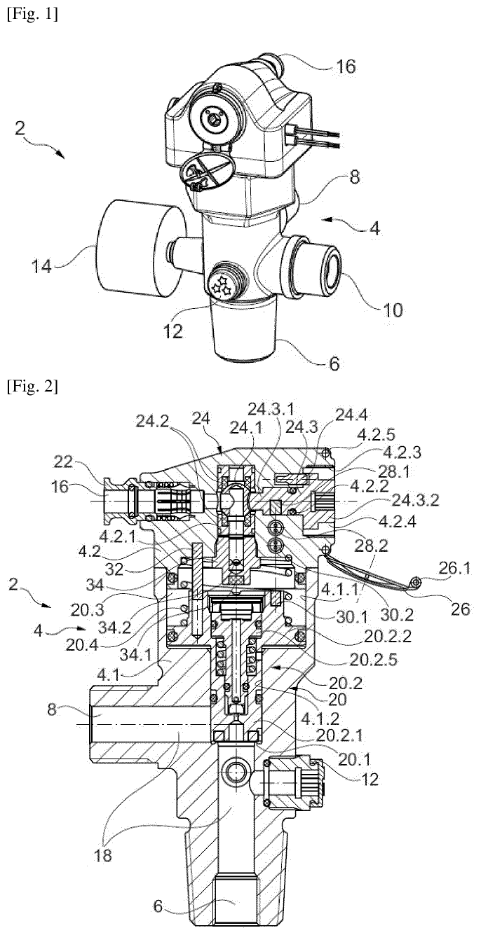

FIG. 1 is a perspective view of a discharge valve for a tank containing a compressed medium like gas, according to the invention.

The discharge valve 2 comprises a body 4 with an inlet 6 and an outlet 8 for the compressed medium, and a passage (not visible) fluidly interconnecting the inlet 6 with the outlet 8.

The discharge valve 2 further comprises a refill port 10, a pressure relief device 12 and a manometer 14, all three directly fluidly connected with the inlet 6 i.e., the potentially high pressure of the tank or gas cylinder to which the discharge valve 2 is intended to be mounted. The refill port 10, a pressure relief device 12 and a manometer 14 are as such classical and as such well-known from the skilled person.

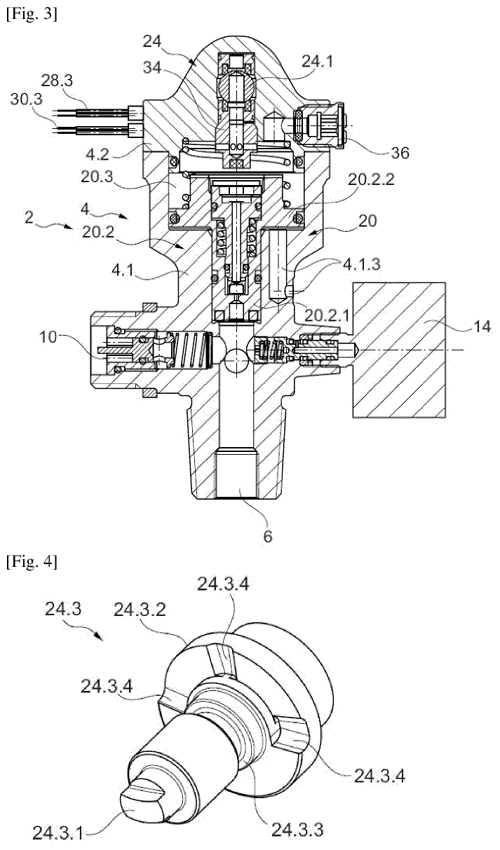

The discharge valve 2 further comprises a shut-off device of the (not visible) passage fluidly interconnecting the inlet 6 with the outlet 8, this shut-off device being however not visible in FIG. 1; it will be described in detail in connection with FIGS. 2 and 3. The discharge valve 2 comprises a control port 16 intended to be fluidly connected to a security conduit or fusible tubing, also not represented, extending through the room(s) or area(s) to be fire-protected. That security conduit, when installed and operatively in connection with the discharge valve, is filled with the same medium or gas as in the tank or gas cylinder onto which the discharge valve 2 is mounted, however at a lower pressure. Maintenance of that reduced control pressure in the control chamber of the discharge valve operatively holds the shut-off device in the closed position and a substantial leak in the conduit due e.g., to melting in case of fire, has for consequence that this control pressure drops down to a level where the shut-off device opens in large so as allow the compressed medium to flow to the outlet 8. The connection of the above conduit can be made via a quick connector 22 specifically designed for flexible conduits.

FIG. 2 is a longitudinal sectional view of the discharge valve of FIG. 1, along a plane passing by the outlet 8, the pressure relief device 12 and the control port 16.

The body 4 is for instance comprised of a main body part 4.1 and a top body part 4.2 attached to the main body 4.1. In the present embodiment, the main body part 4.1 is an integral part forming the inlet 6 and the outlet 8 and comprising the pressure relief device 12 and the refill port (not visible in FIG. 2). It is however understood that the main body part 4.1 can be made of several sub-parts assembled to each other. In the present embodiment, the top body part 4.2 is an integral part, being however understood that it can be made of several sub-parts assembled together.

The top body part 4.2 is, in the present embodiment, screwed on the lower body by non-visible longitudinal screws, for instance four such screws, in two opposed flanges of the main body 4.1, visible in the perspective view of FIG. 1. Usually such a connection is made by the means of one large thread in each part, which always causes orientation issues. This solution ensures that both parts will always be perfectly aligned and removes the need of orientation gauges for both threads.

The above-mentioned passage 18 fluidly interconnecting the inlet 6 with the outlet 8 is well visible. Also, the above-mentioned shut-off device 20 is well visible; it comprises a seat 20.1 located in and around the passage 18, and a movable assembly 20.2 comprised essentially of an obturator 20.2.1 that contacts the seat 20.1 for closing the passage 18, and of a piston 20.2.2 linked with the obturator 20.2.1 and delimiting with a main bore 4.1.1 in the main body part 4.1 a control chamber 20.3 that is in fluidic connection with the above-mentioned control port 16 via a shut-off valve 24, being in FIG. 2 in an open state. As this is apparent, the piston 20.2.2 shows a larger diameter than the effective diameter of the obturator 20.2.1 so that the pressure on the piston generates a larger force on the obturator 20.2.1 than the force resulting of the pressure on the obturator 20.2.1. As this is apparent, the obturator 20.2.1 is slidingly received in a secondary bore 4.1.2 of the main body part 4.1, in a gas tight fashion by means of a seal, being for instance housed in an external groove of the obturator. This medium barrier is necessary for limiting the surface of the movable assembly 20.2 subjected to the inlet pressure. Similarly, the piston 20.2.2 is slidingly received in the main bore 4.1.1 of the main body part 4.1 in a gas tight fashion by means of a seal, being for instance housed in an external groove of the piston 20.2.2. The space between the movable assembly 20.2 and the body 4, delimited between the medium barrier of the obturator and the medium barrier of the piston is vented to the ambient for avoiding any disturbing effect of positive or negative pressure in that space.

The shut-off device 20 can further comprise a spring 20.4 urging the movable assembly 20.2 towards a closed position thereof.

The movable assembly 20.2 can further comprise a pressure regulator 20.2.5 movably housed in the controlled passage of the movable assembly 20.2 fluidly interconnecting the inlet 6 with the control chamber 20.3. The pressure regulator 20.2.5 shows a classical construction, as described in WO 2010/149639 A1, the content of which being incorporated by reference. The pressure regulator 20.2.5 is located downstream of a seat in the control passage and configured for reducing the flow section of the controlled passage and thereby reduce the pressure in the control chamber 20.3 compared with the pressure at the inlet 6.

The shut-off valve 24 in the top body part 4.2 comprises a perforated ball 24.1 and two opposed ball seats 24.2 contacting said perforated ball 24.1, housed in a blind bore 4.2.1 formed in the top body part 4.2. That blind bore 4.2.1 opens out into the control chamber 20.3, thereby ensuring the fluid connection between the shut-off valve 24 and the control chamber 20.3. The shut-off valve 24 further comprises a spindle 24.3 extending transversally, for instance radially, relative to the longitudinal axis of the discharge valve 2. The spindle 24.3 is rotatably housed in a stepped bore 4.2.2 formed in the top body part 4.2. It comprises a proximal end 24.3.1 engaging in rotation with the perforated ball 24.1 and a distal end 24.3.2 accessible from outside the discharge valve 2 and configured for being engaged in rotation by a tool or the hand of an operator. In the present embodiment, the distal end 24.3.2 comprises a central non-circular cavity e.g., hexagon shaped, for engaging in rotation with a male portion of a tool e.g., an Allen key. As this is apparent, the distal end 24.3.2 forms a head that rests on a cavity 4.2.3 formed in the outer side surface of the top body part 4.1. The body 4 can further comprise a ring 4.2.4 that engages with the cavity 4.2.3 formed in the top body part 4.2 and that retains the head formed by the distal end 24.3.2 of the spindle 24.3.

The shut-off valve 24 can further comprise a spring plunger 24.4 housed in a bling hole formed in the cavity 4.2.3, for instance in the bottom thereof, for resiliently engaging with one or more recesses formed on the head formed by the distal end 24.3.2 of the spindle 24.3. This provides to the operator a clear haptic signal that the shut-off valve 24 is moved in a predetermined stable position.

As this is apparent, the shut-off valve 24 is also fluidly connected with the control port 16 via a transversal hole formed in the top body part 4.2. The perforated ball 24.1 comprises a transversal perforation that provides a permanent fluid connection between the control port 16 and a centre of the perforated ball 24.1. The latter comprises a longitudinal perforation to the centre, being on a lower side of the perforated ball 24.2 in FIG. 2. When the perforated ball 24.1 is rotated about its transversal rotation axis, the longitudinal perforation is not aligned with the blind bore 4.2.1 anymore, meaning that the perforated ball 24.1 shows then a totally closed surface to the lower ball seat 24.2 and thereby closes the control chamber 20.3. The perforated ball 24.1 can also comprise a reduced longitudinal perforation, being for instance opposed to the main longitudinal perforation, for providing a fluid connection with a reduced flow section between the control chamber 20.3 and the control port 16.

The discharge valve 2 can further comprise a lid 26 hinged to the body 4, for instance the top body part 4.2 and configured for covering the distal end 24.3.2 of the spindle 24.3, in order to prevent unauthorized access thereto. In particular, the lid 26 can comprise a hole 26.1 that is aligned with a corresponding hole 4.2.5 formed in the body 4, for instance the top body part 4.2, when in the closed or covering position, thereby allowing a tampering wire to be inserted there through.

The discharge valve 2 can further comprise an electric detector of position of the shut-off valve 24. That electric detector advantageously detects the angular position of the spindle 24.3. In the present embodiment, the electric detector comprises a permanent magnet 28.1 housed in the spindle 24.3 and a reed contact 28.2 housed in a hole formed in the top body part 4.2, at proximity of the spindle 24.3 and the permanent magnet 28.1 so that it can be activated when the spindle 24.3 is rotated such that the permanent magnet is in close proximity to the reed contact 28.2.

The discharge valve 2 can further comprise an electric detector of position of the piston. That electric detector advantageously detects the translational position of the piston 20.2.2. In the present embodiment, the electric detector comprises a permanent magnet 30.1 housed in a hole formed in an upper surface of the piston 20.2.2 and a reed contact 30.2 housed in a hole formed in the top body part 4.2, at proximity of the control chamber 20.3 and the permanent magnet 30.1 so that it can be activated when the piston reaches its upper most position, opposed to the one visible in FIG. 2.

The discharge valve 2 can further comprise a rod 32 engaging longitudinally with the body 4, for instance the top body part 4.2, and with the piston 20.2.2 so as to prevent rotation of the piston 20.2.2 relative to the body 4. This is particularly useful when the above electric detector of position of the piston is present. The rod 32 can be rigidly attached to the body or to the piston. It can also be slidably engaged with both the piston 20.2.2 and the body 4.

The discharge valve 2 can further comprise a spigot 34 engaged in the opening of the blind bore 4.2.1, thereby retaining the ball seats 24.2 in position and in contact with the perforated ball 24.1. This engagement is preferably a threaded one. The spigot 34 extends longitudinally into the control chamber 20.3 with radial passages 34.2 for the medium and with a front sealing surface 34.1 configured to be engaged in a medium tight fashion with a corresponding seat of the controlled passage on the pressure regulator 20.2.5, when the movable assembly 20.2, for instance the piston 20.2.2, is in its upper most position, being opposed to the lower most position visible in FIG. 2. In such an engagement position, the controlled passage through the movable assembly 20.2 is closed.

FIG. 3 is a longitudinal sectional view of the discharge valve of FIG. 1, along a plane passing by the refill port 10 and the manometer 14, this sectional view being perpendicular to the one of FIG. 2.

In FIG. 3, the above-mentioned venting with the ambient of the space between the movable assembly 20.2 and the body 4, delimited between the medium barrier of the obturator 20.2.1 and the medium barrier of the piston 20.2.2 is visible; it is formed by the drillings 4.1.3 in the main body part 4.1.

Also, the electrical wires 28.3 and 30.3 connecting to the reed contacts 28.2 and 30.2 of the electric detectors of position of the shut-off valve 24 and of the piston 20.2.2, respectively, are visible.

We can also observe that the discharge valve 2 can also comprise a pressure relief device 36 for the control chamber 20.3.

FIG. 4 is a perspective view of the spindle 24.3 of the shut-off valve 24 of the discharge valve 2 of FIGS. 1 to 3.

The proximal end 24.3.1 is well-visible and comprises for instance two flattened parallel surface, parallel to the main axis of the spindle 24.3, for engaging in rotation with a corresponding slot in the perforated ball of the shut-off valve. The distal end 24.3.2 is also well-visible, with a transversal rear surface comprising recesses 24.3.4 for engaging with the spring plunger 24.4 (FIG. 1) mentioned above. The spindle 24.3 can also comprise a circular external groove 24.3.3 for receiving a gasket e.g., an O-ring, for providing a medium tight barrier with the body 4, for instance the top body part 4.2.

The above-mentioned discharge valve operates as follows, with reference mainly to FIG. 1.

The movable assembly 20.2 of the shut-off device 20 is normally closed by virtue of the spring 20.4, whereby the obturator 20.2.1 contacts the seat 20.1, whereas the controlled passage through the movable assembly 20.2, controlled by the pressure regulator 20.2.5, is normally opened.

Once the discharge valve 2 is mounted on a tank e.g., a cylinder, and before filling said tank, the shut-off valve 24 is operated to be in a closed state, thereby shutting-off the fluid connection between the control port 16 and the control chamber 20.3.

During filling of the tank via the refill port 10, the pressure in the tank and at the inlet 6 progressively increases. The gas or medium filled in the tank flows then through the controlled passage formed by the pressure regulator 20.2.5 being normally opened, whereby the gas or medium flows to the control chamber 20.3. The pressure in that chamber increases progressively having for effect to progressively close the controlled passage through the movable assembly 20.2 by a progressively closing relative movement of the pressure regulator 20.2.5. The above increase of pressure in the control chamber 20.3 has for effect to result in a force opposed to and overcoming the force resulting of the inlet pressure on the obturator 20.2.1, thereby pressing the obturator 20.2.1 against the seat 20.1 and closing the shut-off device 20. To that end, the effective surface of the piston 20.2.2 in contact with the medium in the control chamber 20.3 is larger than the effective surface of the obturator 20.2.1 in contact with the medium at the inlet pressure. This surface difference allows the pressure in the control chamber 20.3 to be lower than the inlet pressure while still urging the obturator 20.2.1 against the seat 20.1. The pressure regulator 20.2.5 regulates the pressure in the control chamber 20.3 at a level that is lower than the nominal inlet pressure.

The above-mentioned security conduit(s) or tubing, installed in the room(s) or areas to be protected can then be fluidly connected to the control port 16 of the discharge valve 2. This connection can of course be done before, during or after the above filling operation of the tank.

Once the security conduit or tubing is installed and fluidly connected to the discharge port 16 and the tank is filled, the shut-off valve 24 can be opened, so as to allow the compressed medium to flow into said conduit or tubing, until it reaches the same pressure as in the control chamber 20.3. The shut-off valve 24 is advantageously opened through the reduced longitudinal perforation in the perforated ball 24.1, being for instance opposed to the main longitudinal perforation, for providing a fluid connection with a reduced flow section between the control chamber 20.3 and the control port 16. This reduced flow section allows the medium to flow progressively into the security conduit(s) or tubing while allowing the pressure reducer 20.2.5 to compensate for the medium flowing to said security conduit(s) or tubing.

The security conduit or tubing needs of course to be closed i.e., to show no leak and to open e.g., by melding, in the presence of fire. In such a case, the pressure in the control chamber 20.3 will drop down so that the resulting force on the movable assembly 20.2 counteracting the opening force resulting of the inlet pressure does not counteract said opening force anymore, allowing movement of the movable assembly 20.2 opening the passage 18. When the movable assembly 20.2 is moved to a total opening of the passage 18, the seat on the pressure regulator 20.2.5 contacts the sealing surface 24.1 on the spigot 34, resulting in closing the controlled passage throughs said movable assembly 20.2. In that position, the inlet pressure cannot feed the control chamber 20.3 anymore.

1.-15. (canceled)

16. A discharge valve for a tank containing a compressed medium, said discharge valve comprising:
a body comprising:
an engaging portion for sealingly engaging with the tank,
an inlet,
an outlet, and
a passage fluidly connecting the inlet and the outlet;
a shut-off device in the passage, comprising:
a seat in the passage;
a movable assembly comprising:
an obturator for cooperating with the seat;
a piston delimiting in the body a control chamber; and
a controlled gas passage fluidly interconnecting the control chamber with the inlet;
a control port located on a top body part closing the control chamber, and fluidly connected to the control chamber; and
a shut-off valve fluidly between the control chamber and the control port, the shut-off valve comprising:
a perforated ball and ball seats housed in a bore formed in the top body part and opening out in the control chamber; and
a spindle extending transversally through the top body part and with a proximal end engaging with the perforated ball.

17. The discharge valve according to claim 16, wherein the spindle comprises a distal end shaped for being engaged by a tool or an operator's hand.

18. The discharge valve according to claim 17, wherein the distal end of the spindle is housed in a cavity formed in a lateral outer surface of the top body part.

19. The discharge valve according to claim 18, wherein the cavity comprises a hole housing a spring plunger configured for selectively resiliently engaging with one or more recesses formed on the distal end of the spindle, corresponding to predetermined position(s) of the shut-off valve.

20. The discharge valve according to claim 18 further comprising a ring engaging with the cavity and the distal end of the spindle so as to retain the distal end in the cavity.

21. The discharge valve according to claim 17 further comprising a lid hinged on the body and configured for covering the distal end of the spindle.

22. The discharge valve according to claim 21, wherein the lid and the body comprise holes through which a tampering wire can be inserted when the lid is in a closed position preventing access to the distal end of the spindle.

23. The discharge valve according to claim 16 further comprising:
an electric detector of position of the shut-off valve.

24. The discharge valve according to claim 23, wherein the electric detector of position of the shut-off valve comprises:
a permanent magnet attached to the spindle; and
a reed contact housed in a hole of the top body part at proximity to the permanent magnet of the spindle so as to be able to be activated by the permanent magnet when the spindle is rotated in a predetermined position.

25. The discharge valve according to claim 16 further comprising:
an electric detector of position of the piston.

26. The discharge valve according to claim 25, wherein the electric detector of position of the piston comprises:
a permanent magnet attached to the piston; and
a reed contact housed in a hole of the top body part at proximity to the permanent magnet of the piston so as to be able to be activated by the permanent magnet when the piston is in an upper position in contact with, or at least adjacent to the top body part.

27. The discharge valve according to claim 26 further comprising:
a rod engaging longitudinally with the body and with the piston so as to prevent rotation of the piston relative to the body.

28. The discharge valve according to claim 16 further comprising:
a spigot engaging the bore formed in the top body part and retaining the perforated ball and the ball seats in the bore, the spigot extending longitudinally into the control chamber with radial passages for the medium and with a front sealing surface configured to be engaged in a medium tight fashion by the controlled passage when the piston is in a raised position adjacent the top body part.

29. The discharge valve according to claim 28, wherein the obturator and the piston are rigidly fixed to each other and comprise a pressure regulator slidably received in the piston and obturator, and forming the controlled passage between the inlet and the control chamber, the pressure regulator comprising a seat around the controlled passage, configured for engaging with the sealing surface of the spigot.

30. The discharge valve according to claim 16, wherein the control port is orientated transversally, opposed to the spindle relative to the shut-off valve.
